(19) United States
(12) Patent Application Publication
(10) Pub. No.: US 2001/0047308 A1
(43) Pub. Date: Nov. 29, 2001

(54) Concurrent dynamic pricing marketing and selling system

(76) Inventors: Joseph Kaminsky, Scottsdale, AR (US); Frank Fiore, Paradise Valley, AR (US)

Correspondence Address: ST. ONGE STEWARD JOHNSTON & REENS, LLC, 986 BEDFORD STREET, STAMFORD, CT, 06905-5619, US

(21) Appl. No.: 09/816,918

(22) Filed: Mar. 23, 2001

Related U.S. Application Data
(60) Provisional application No. 60/193,739, filed on Mar. 31, 2000.

(51) Int. Cl. G06F 17/60

(52) U.S. Cl. 705/26

(57) ABSTRACT

A system for liquidating excess, returned, inventory of slow moving products to maximize gross profit. The system has a variable pricing strategy for enabling quick liquidation of unsold or returned inventory items. The system is Web based. The pricing strategy is interactive, and includes a flexible current price, an open order mechanism, a facility for a demand price and a buyer auction scheme. Sellers interact with the system to set minimum prices and permitted increments of changes in price when prices vary. Buyers can choose to acquire a certain amount of a product at the current price, or set an amount they are willing to pay after a particular period of time. Sellers can adjust prices based on buyer responses and arrive at an optimal pricing strategy over a given period of time to meet their requirements for inventory liquidation. The system can be used in on-line shopping forums and is available through a number of access points including affiliated websites, distributor and manufacturer websites and portal type websites. The system permits the liquidation of excess or returned inventory in a desired amount of time with an improved recovery price.

This application is based on and claims benefit of Provisional Application No. 60/193,739, filed Mar. 31, 2000, entitled Network-Based Multi-Dimensional Marketing System, to which a claim of priority is made.

### BACKGROUND OF THE INVENTION

1. Field of the Invention

This invention generally relates to a marketing and sales system using a network, and more particularly, relates to a system of selectable rules which provide flexible and dynamic sales and marketing approaches concurrently.

2. Description of the Related Prior Art

Consumer shopping using on-line or electronic forums has been known for some years. With the advent of the Internet and the World Wide Web, access to merchants and consumers alike has increased dramatically. Ease of use and decreased overhead have contributed to making on-line shopping forums both attractive and affordable.

As participation in on-line shopping has increased, various pricing methodologies available through the uniqueness of the above described mediums have been explored. One such method is known as dynamic pricing, in which the price of a given item fluctuates with demand.

Dynamic pricing methods have been used successfully in on-line forums where buyers wish to purchase similar or identical items. These on-line forums are typically described as auctions or a “name your price” system in which a number of potential purchasers can review products offered by one or more manufacturers. Typically, an auction-type forum permits a number of bidders to submit prices which they are willing to pay for a particular item, over a particular period of time. For example, a product may be offered in an on-line forum, which may be reviewed by a number of purchasers over the course of a week. Each person reviewing the item may potentially submit a bid on the item within certain constraints, such as a minimum price. Once the set period of time has passed, in this instance a week, the highest bidders will receive the item for sale. If there were no bids over the fixed price for permitting a sale, then no sale is made.

This type of on-line auction is typically referred to as a vertical auction. That is, the potential purchasers bid against one another in a single forum for a unique item, or a group of unique items.

Another approach to on-line sales is to take advantage of reduced overhead costs associated with sales on the Internet. Merchants typically offer items for sale on a website, which are identical or very similar to products offered in retail stores. The fact that merchants generally do not have to pay for retail space to advertise or sell these items on line, means that the sales price can be reduced relative to traditional retail stores. In addition, a purchaser may find it much more convenient to shop and purchase items on-line, rather than travel to a retail store to obtain merchandise. In this sense, a merchant's website can function as an electronic catalog that provides purchasers with a product discount.

While a number of approaches outlined above may be used on a particular website, a variety of types of websites are available in various marketing sectors. For example, a distributor may have access to a large inventory made up of goods from a variety of manufacturers, which the distributor may make available on a number of on-line forums. At the same time, each of the manufacturers of the goods may have a website or other on-line forum through which they offer their goods directly to consumers, or to other distributors. A distributor may also feature links to manufacturers' websites for further product information or help. Distributors may also elicit the assistance of distribution channels for purposes such as discounted or overstocked items. These distribution channels may be volume discount resellers, damaged lot goods resellers or the like. Each of these types of resellers may further utilize on-line forums to dispose of their goods. In whatever type of approach used by a merchant, or group of merchants, it is typical for a website to feature products offered by a large number of manufacturers. Such a website may also offer links to manufacturers' websites. An individual seeking to purchase one of the manufacturer's products may go to the website and determine that the product may be offered by local distributors or other qualified vendors. The site may contain links to the distributors or the qualified vendors, so that the purchaser can go directly to the websites which offer the item they are seeking.

As another example, an individual may be accessing a website dedicated to a particular interest or hobby, on which there may exist a link to a vendor's site, on which is offered a number of products related to the individual's interest or hobby. The individual need only click on the link to go to the site and be offered a variety of the products.

The above described purchasing system is typically referred to as a direct business to consumer (B2C) type of approach for selling products on line. However, merchants, resellers or distributors can also take advantage of the same sort of approach. For example, a retail merchant may wish to ensure that certain levels of inventory are maintained to meet their customers needs. When the merchant deals with a supplier that offers access to its products on-line, the merchant and the supplier can engage in business to business (B2B) transactions. These type of transactions are similar to the B2C type of transaction, except that two merchants are involved. Based on the merchants' relationships, advantages such as automatic stocking and inventory control can be achieved. In addition, overall inventory levels can be reduced, resulting in a reduction in overhead costs associated with inventory storage.

Businesses which can conduct commerce electronically need not be strictly limited to a supplier-distributor type relationship. For example, a business may offer to sell a product lot to a number of other businesses, each of which would bid for the product lot. A particular business may also wish to have a presence on a website which containing content which could be associated with products related to the business, and would compensate the website owner for the opportunity to provide a link to the business' web page, or a specific area of the business' website. A business wishing to have a presence on an associated website may include a “sticky” functionality, which would allow the user, whether an individual or a business, to return to the original associated site after viewing the business' website.

Other advantages of on-line sales and marketing approaches involve the development of customer profiles, customer lists and an option for corresponding directly to a customer through E-Mail. For example, once a purchaser completes a transaction on a website, their information submitted in the course of the transaction can be recorded for future use. A profile can be developed over time which reflects the purchasers' interests and preferences. The purchaser can also be offered the option of being contacted by E-Mail if a particular offer matching their profile becomes available. This type of an approach to satisfy customer desires, also referred to as a type of data mining, helps the merchant tailor their products and offerings to particular groups of consumers, or even individuals. The resulting increase in efficiency for sales and marketing models helps to reduce the merchant's overhead while contributing to increasing profitability.

The approaches and facets of sales and marketing approaches discussed above all share the difficulty of dealing with returned, overstocked or end-of-life inventory in an efficient and cost effective manner. Many types of businesses lose money on merchandise which can no longer be sold through the businesses' existing distribution channels at an acceptable recovery rate. Typically, the longer this type of inventory is held, the less valuable it becomes. It is not unusual for businesses to receive a return of 10 to 15 cents on the dollar for these types of items which they are required to move from their inventory.

Typical rates for merchandise return and overstocking of inventory run around 10% in both areas respectively. In a recent holiday season, close to fifty million orders were placed on line. The resulting excess inventory ran around ten million units. The loss of profits with respect to these items runs in the billions of dollars. Retailers and merchants will typically sell their overstocked and returned items to third parties for a considerable discount. In addition, the longer an item is held in inventory, the less valuable the merchandise becomes.

The present invention solves the problems of the prior art by providing an electronic system for efficiently disposing of returned and overstocked inventory. The present invention realizes a number of advantages for retailers and merchants in improving their excess inventory recovery rate.

### SUMMARY OF THE INVENTION

It is an object of the present invention to provide a marketing and sales system which overcomes the above described drawbacks of conventional systems.

Briefly stated, there is provided according to the present invention a system for liquidating excess or returned inventory in which the system has a variable pricing strategy for quickly liquidating unsold or returned inventory items. The pricing strategy is interactive, and includes a flexible current price, a facility for a demand price, an open order mechanism and a buyer auction scheme. Sellers interact with the system to set minimum prices and permitted increments of changes in price or when price changes are displayed. Buyers can choose to acquire a certain amount of a product at the current price, or set an amount they are willing to pay over a particular period of time. Sellers can adjust prices based on buyer responses and arrive at an optimal pricing strategy over a given period of time to meet their requirements for inventory liquidation. The system can be used in on-line shopping forums and is available through a number of access points including affiliated websites, distributor and manufacturer websites and portal type websites. The system permits the liquidation of excess or returned inventory in a desired amount of time with an improved recovery price.

This system permits a merchant to dynamically price enable a single product, a group of products or an entire website.

According to an embodiment of the present invention there is provided a marketing system for providing a buyer access to inventory items of a seller, comprising: an inventory presentation tool accessible to a plurality of buyers through at least one medium, the inventory presentation tool being effective to provide an indication of an available quantity of an item and a plurality of pricing schemes, at least one of the pricing schemes permits the buyer to request an immediate purchase at an immediate purchase price and at least another of the pricing schemes permits the buyer to request a deferred purchase at a deferred purchase price.

The merchant establishes the business rules i.e. price, reserve price, percentage movement of the product prices and the time expiration of the offer among other variables related to the business rules.

### BRIEF DESCRIPTION OF THE DRAWINGS

The above, and other objects, features and advantages of the present invention will become apparent from the following description read in conjunction with the accompanying drawings in which:

FIG. 1 is a schematic diagram of the interconnectivity provided by the system of the present invention;

FIG. 2 is a schematic representation of the functional components of the system according to the present invention;

FIG. 3 is a graphic representation of an embodiment of the system according to the present invention; and

FIG. 4 is a graphic representation of another embodiment of the system according to the present invention.

### DETAILED DESCRIPTION OF THE PREFERRED EMBODIMENTS

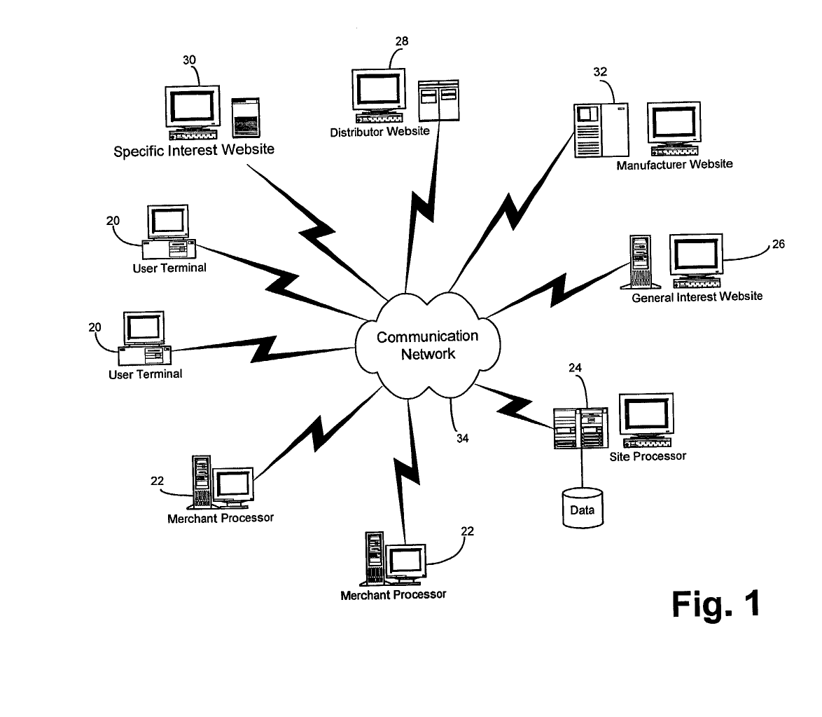

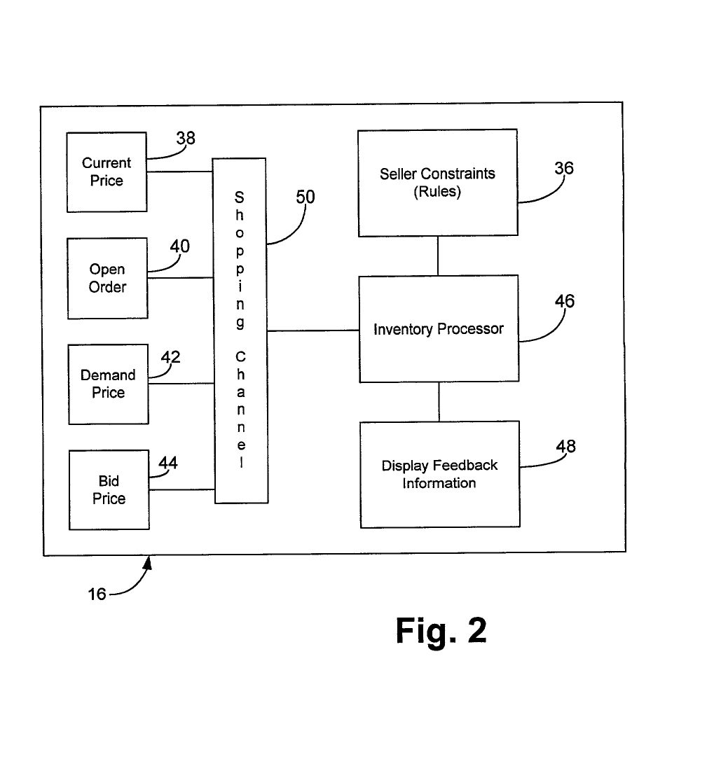

Referring now to FIGS. 1 and 2, a diagram of the components of the overall system is shown. Each of the interface components are interconnected through a public communication network 34 such as, for example, the Internet. User terminals 20 are used to browse various content sites provided by, among others, merchant processors 22. User terminals 20 represent access to the Internet available to consumers, manufacturers and merchants. Consumers, manufacturers and merchants can access a sales tool 16 which is available over a communication network such as the Internet. From a consumer viewpoint, access to sales tool 16 can appear on a given website as an icon, a button or a branded link. A branded link offers the consumer a well-known brand name in association with sales tool 16 to promote consumer responsiveness.

Once the consumer accesses sales tool 16, they are presented with a shopping channel 50 for choosing a type of merchandise in which they are interested. Depending on the type of access to sales tool 16, shopping channel 50 may be preselected, and the consumer display will bypass selection of shopping channel 50.

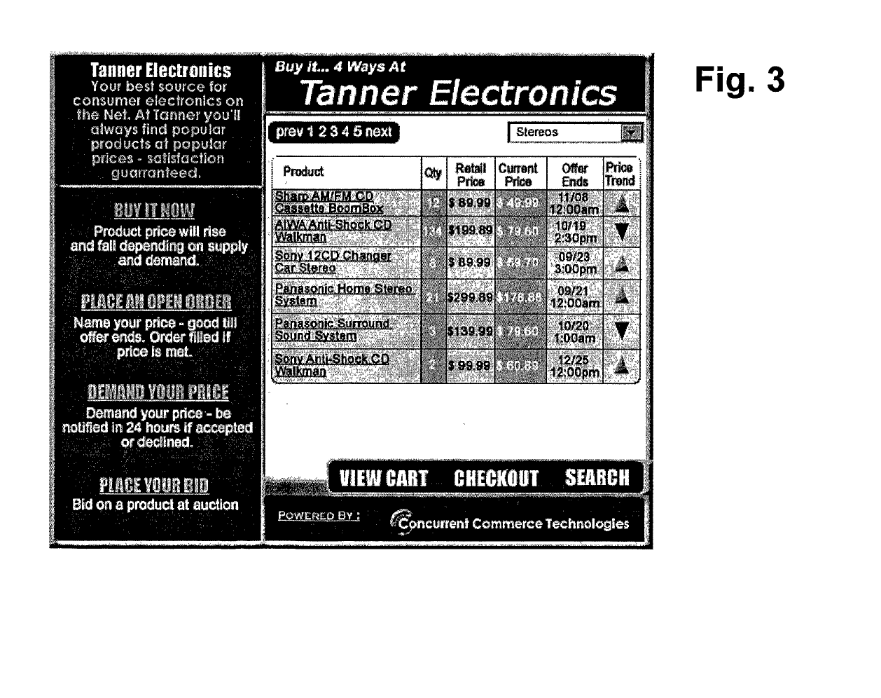

Referring to FIG. 3, the consumer is then presented with a number of inventory items, each with an associated quantity, retail price and a current price 38. The consumer can then select an item and a purchasing method as discussed below.

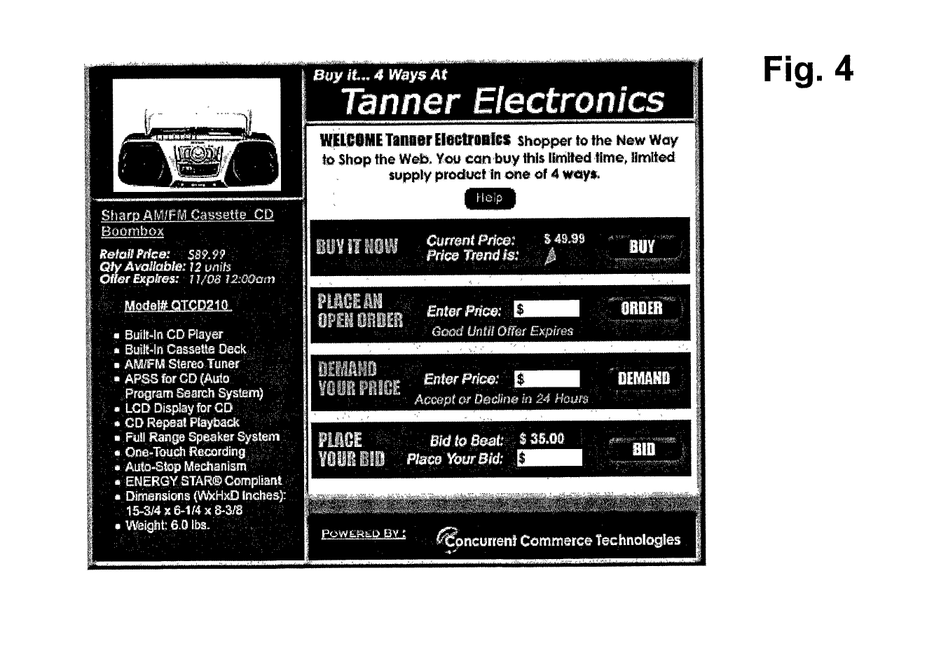

Referring also to FIG. 4, another embodiment of sales tool 16 according to the present invention is shown. In this embodiment of the present invention, a particular item is shown with information about retail price, quantity, when an offer expires and details about the item. Also displayed are the various purchasing options together with current information regarding the various options, such as the present bid to beat according to an auction option.

A manufacturer catalog company, an e-tailer or other merchant may use sales tool 16 from a seller's viewpoint to dispose of excess inventory. The merchant may host a website 32 which provides access to sales tool 16, through which the merchant may offer various merchandise. The merchant sets various parameters in sales tool 16 as described in more detail below. In addition, the merchant can view various sales using sales tool 16 and reevaluate a sales strategy.

A merchant can use sales tool 16 from the viewpoint of a buyer and a seller. For example, the merchant may purchase inventory items from other merchants or manufacturers for resale, in the same fashion as described above with respect to consumers. The merchant may also sell products using sales tool 16, and set parameters and receive feedback in the same way the above described manufacturers would.

Sales tool 16 according to an embodiment of the present invention offers the user the choice of a shopping channel 50, which is related to a particular category of goods as discussed above. Once shopping channel 50 is chosen, the user is offered all the products in that particular channel which are available for purchase. The user can then select a product to purchase, and choose a dynamic pricing method for completing the sale.

The first pricing method uses an immediate price strategy, and works on a simple principle of supply and demand. The user is shown a quantity of a particular item which is available, a retail price, a current price 38, a time and date at which an offer of sale for the item ends and whether current price 38 is trending up or down. The immediate price strategy for clearing excess inventory makes the user aware of some of the issues related to the product's market status. The user can then make an informed decision whether to purchase the item immediately, wait until the market situation is more favorable or choose another method of purchase.

The user may also purchase a product by placing an open order 40. This approach is similar to the immediate price strategy, except that the user may seek a purchase price lower than current price 38. The user places open order 40 at a price below current price 38, and awaits the results of shifts in price trends. If current price 38 reaches the price submitted in open order 40 due to shifts in pricing trends, open order 40 is filled and the user receives the product. Open order 40 is valid for the length of time for which the product offer is open. Thus, open order 40 may be made or filled at anytime during the product offering provided that the pricing criteria is met.

The interested shopper can also submit a demand price 42. This approach permits the shopper to request and commit to a set price below current price 38 of the item. Demand price 42 is good for twenty-four hours, and is either accepted or declined based on a set of business rules determined by the particular merchant. For example, if the merchant wishes to dispose of an entire lot of products, and demand prices 42 received over a twenty-four hour period total the price desired by the merchant for the entire lot, all demand prices 42 are accepted. If all of demand prices 42 do not total the amount desired by the merchant for the lot, then only those demand prices 42 which exceed the average price for the items in the lot will be accepted, and all others will be declined. Each demand price 42 is evaluated at a given point over a twenty-four hour period until expiration of the time period for which the item is offered. Thus, each demand price 42 will be evaluated within twenty-four hours of when it is submitted, and either accepted or declined based on the criteria for demand price 42. Each buyer is isolated in their purchases from any other demand price buyer, and is not aware of other demand prices 42 made by other shoppers. The number of items available for demand pricing may change as items are sold through the above-mentioned current price 38 and open order 40 sales approaches.

Another approach a shopper can take to acquire the item at a reduced price is by submitting a bid price 44 in a variable auction. According to this approach, the merchant sets an initial start price for each product in the lot and chooses a bid increment. Shoppers choosing to use this auction approach submit bid prices 44 for the available products. The top bid prices 44 for the product are displayed to all users viewing information about that particular product. Once the auction is completed, the orders with the highest bid prices 44 for the product is filled. Bid price 44 is not limited to a single item, but can be submitted for a quantity of a particular product as well.

A winning bid price 44 for a quantity of a particular product may not necessarily be equivalent to the highest bid price 44 for an individual item. Again, the number of items available through the variable auction approach is reduced as purchases are made through current pricing and demand pricing approaches mentioned above. Since a shopper can submit bid price 44 for a quantity of the products offered, an initial bid price 44 based on volume discount perceptions, may be very attractive to both the bidder and the seller, especially if there is a large quantity of products. However, as the quantity of goods available drops due to purchases made using current price 38, open order 40 or demand price 42 approaches, the previously submitted quantity bid price 44 may no longer be as competitive. Other bid prices 44 for smaller quantities at higher prices will typically begin to appear in greater numbers as the total quantity of items decreases, putting the previous bid prices 44 out of the running. The variable auction provides an incentive to submit higher bid prices 44 for a given quantity of goods, as the total number of goods is reduced through the above-mentioned pricing methods. In addition, if the highest bid price 44 in the variable auction rises above current price 38, current price 38 is increased above the highest bid price 44 regardless of whether the trend of current price 38 is rising or falling.

A shopper can purchase products using any one or all of the above-mentioned pricing strategies. All product orders are added to a “shopping cart” which displays the shopper's purchases upon checkout. When the shopper checks out, all the purchases of the current session are displayed, along with their various pricing strategies under which they were purchased. The shopper can view the shopping cart at any time to review their order and the different pricing strategies under which products were purchased. In addition, the shopping cart screen can offer a special or bonus type deal when the shopper views the shopping cart.

Once the shopper is satisfied with all of their selections, they can checkout and review the cost for all of their purchases. The checkout screen is similar to the shopping cart screen in that it displays all of the shopper's purchases, with each product listed in its pricing strategy category. The cost of each product in their respective quantities is totaled and displayed to the user. The total will include open orders 40, demand prices 42 and bid prices 44, which have not necessarily been filled when the user checks out. Demand prices 42 will be processed within a twenty-four hour period after checkout.

Once the user checks out, they are presented with a request for payment information, such as credit card information. Any payment information is transmitted over a secure channel and encrypted to protect the individual's personal and financial data. The payment is confirmed by the system and the user receives and order number reflective of their purchase. The order is also confirmed through E-Mail, which can contain customer service representative contact information.

Typically, a business entity with excess inventory will wish to dispose of the inventory quickly and efficiently, while retaining as much value for the inventory products as possible.

A business entity with excess inventory can use the system according to the present invention to dispose of their excess inventory in aggregate, or one piece at a time. Aggregate sales typically dispose of excess inventory in lots with a price set that is equivalent to a wholesale price. Individual items are sold singly with prices subject to change on an individual basis. The business entity can set either a floor, or minimum price for the product they wish to offer, or investigate a dynamic pricing model to dispose of the excess inventory in a way which maximizes a specified criteria.

The system according to the present invention permits a business entity to take advantage of several different forums for disposing of excess inventory. The first forum available through this system is a large number of general commerce websites viewed by large numbers of consumers on a constant basis. These websites can be oriented to a particular community, interest or area of commerce, and are each affiliated with a centralized entity for offering the excess inventory products.

Another forum for clearing excess inventory is through a particular business entity selling its own excess inventory on the Internet. The business entity can use a tool according to the present invention on their website to offer methods to the public by which excess inventory can be cleared quickly.

Another technique to provide access to a forum is to attach a company's icon or banner to the tool according to the present invention. When the company is affiliated with a number of other websites, each of those websites can carry a button associated with the company which permits the user to access the company's excess inventory products which are desired to be liquidated.

Using the system of the present invention, merchants are able to set simple rules for how the products will be offered, according to their needs for disposing of excess inventory. At a high level, the merchant can choose whether to focus their strategy on price or an amount of time during which they wish to have sold all of the their excess inventory. Each of these high level choices involves strategic use of the four different dynamic concurrent pricing strategies to best achieve the merchant's goal. The term “concurrent” is intended to mean a system wherein products are sold concurrently across multiple dynamic sales methods.

With regard to a best pricing focus, the merchant can set rules for current price 38, open order 40, demand price 42 and bid price 44. For the current price 38, the merchant can choose a start price for each product in a given lot which is 20 to 40% off of the regular list price, for example. The merchant then sets a time increment over which price fluctuations are reported. Again, the price fluctuations will depend on supply and demand between the seller and the purchasers.

The merchant then also sets the percentage increment by which current price 38 of a product can move up or down. Current price 38 will drop a certain percentage over a given period of time (i.e., 3% drop every 6 hours) as set by the seller if the demand is low. If there is greater demand for the product, an appropriate increase will be made to the current price 38 of each product. Accordingly, after each purchase, current price 38 of the product will rise by a certain percentage increment (i.e., 1% rise), again as set by the seller. According to an embodiment of the invention, current price 38 is preferably the highest price available through any of the four dynamic concurrent sales methods. If bid price 44 given by the highest bid in the variable auction increases above current price 38, current price 38 is increased to reflect the amount of the highest bid. This price increase resulting from elevated bids in the variable auction will occur regardless of whether current price 38 is trending up or down. Moreover, each user/shopper will be able to see a real time display of the quantity of particular products available and be able to assess the relative value of a product through the various price strategies. The user/shopper can then make decisions about purchases based on how quickly, or at what price, an item is selling, for instance, choosing to purchase at current price 38 rather than waiting for better prices under any other price scheme.

The demand pricing dynamic model permits the merchant to set a price for an entire product lot. The total price for the lot is used to determine an average price for each individual product in the lot. Over a period of twenty-four hours, the various demand prices 42 are aggregated and analyzed to determine if they meet the requirements set by the merchant for the lot. If the aggregate amount of demand prices 42 meets the total amount for which the merchant wishes to sell the entire lot or that portion for which demand prices 42 were submitted, all demand prices 42 are accepted, regardless of the amount of variation between the various demand prices 42. If the aggregate amount of demand prices 42 does not meet the price set by the merchant for the lot or portion of the lot, the set of demand prices 42 are examined to find those which are at or above the average price for each product in the lot. Demand prices 42 which meet the average price, or exceed it, are accepted while all other demand prices 42 are declined.

As an example, a merchant may wish to sell ten products at a total price of $50 for the entire lot. The average price is thus calculated to be $5 for each piece in the lot. If individual demand prices 42 are submitted on five items over a twenty-four hour period, and the submitted demand prices 42 total $25, all of the demand prices 42 are accepted. This is true even if four demand prices 42 are $1 and one demand price 42 is $21. However, if five demand prices 42 are made over a twenty-four hour period and the aggregate totals only $9, for instance, then the entire lot is not sold. If the five demand prices 42 are composed of four requests at $1 and one request at $5, then the $5 offer will be accepted as meeting the average item price set by the seller, while the other offers are declined. It is important to note that none of the shoppers submitting demand prices 42 know what any other shopper has submitted as a demand price 42. Shoppers thus make anonymous demands which will be accepted or declined individually within twenty-four hours. As the quantity of products is reduced through purchasers who take the product at current price 38, the number of products available for the demand pricing strategy is reduced and displayed for shoppers to see.

The variable auction pricing strategy approach permits the merchant to set a start price for each product in a given lot, and then set an auction bid increment. Each shopper can then submit a bid price 44 on one or more products in the lot. The highest bid prices 44 for set quantities of product are displayed to other shoppers in the variable auction pricing strategy. When the auction is over, the highest bid prices 44 for the specified number of products are filled, while all other bids are declined. As mentioned previously from the perspective of the shopper, the number of products available in the variable price auction is reduced as products are purchased through the above-mentioned pricing strategies. A bidder may have the highest bid price 44 for a set number of items, and become a lower bidder as the quantity of products is reduced. Again, if the highest bid price 44 in the variable price auction rises above current price 38 at which the item is listed, current price 38 will be increased to be greater than that of the highest bid price 44. This increase in current price 38 will occur regardless of whether the trend for current price 38 is upward or downward.

With the regard to the open order price arrangement, there is no requirement that the merchant set any particular criteria for the individual products or the lot. Simply, if an open order 40 is placed, it will be filled if current price 38 meets the price specified in open order 40. Open order 40 submitted by the shopper is valid until the offer for the particular product and/or lot is ended. The filling of open order 40 therefore only depends on the length of time for which the offer is extended, and the fluctuation in price as products are sold.

As products are sold, or as shoppers make offers on products using the various pricing strategies discussed above, the merchant can observe the sales and offers and adjust prices accordingly. For example, the merchant can set different minimum prices for each product, or modify the price for the entire product lot prior to the expiration of the offer. This adjustment permits the merchant to achieve a very good price for the offered products, which are sold within a desired amount of time.

A merchant wishing to offer returned or excess inventory items can also specify a time focus related to the amount of time for which a product is offered. A product offering time period can be varied among the different types of pricing strategies. For example, a merchant can set a time period for which current price 38, is offered which is different from the time period for which the product is offered under demand price 42 or variable auction pricing strategies. Demand price 42 has a fixed time frame of twenty-four hours for shoppers to be informed whether their demand prices 42 have been accepted or declined. The variable auction pricing strategy has a minimum time period of, for example, at least five days for shoppers to submit bid prices 44. However, the merchant can set the upper limit on the length of time for which the auction will run, which can be different than the length of time for which the product is offered under an immediate pricing scheme, as discussed above.

Through the use of the above described focus models with regard to pricing and time, a merchant can choose how best to dispose of returns and excess inventory, using the various pricing strategies. The merchant selections permits consumer access to the various products in a number of dimensions, which significantly improves buyer competitiveness in seeking to obtain the products offered. In addition, as quantities of a particular product decrease due to sales through the various strategies, potential buyers are placed under pressure to decide whether they wish to quickly purchase a product which may sell out immediately, or continue to wait for a potential purchase at a lower price using the time variable pricing strategies. The result of this pressure is that the merchant can sell a greater number of returned or excess inventory items in a shorter amount of time, while recovering a higher percentage of the product's value.

It should be readily observed that the shoppers can consist of, for example, individual consumers, bulk purchasers for redistribution, purchasing agents who wish to obtain excess inventory or consumer warehouse type outlets which sell consumer products at wholesale rates. The merchant also has the option of deciding where their products will be listed. The merchant can choose one or more forums through which potential customers will access the present invention to permit the merchant's products to be made available. As was mentioned above, for example, the merchant's products can be made available on affiliate websites related to a particular community, interest or area of commerce. The merchant can also offer their excess inventory products through their own dedicated website. In addition, a well-known Internet marketing entity can be provided with a branded custom tool to access the system of the present invention, which may appeal to an audience desiring the market recognition of the Internet entity.

The system of the present invention also offers a facility for the shopper to select notices by E-Mail. If the user chooses this option, they will be provided with special deals or products which may be specific to a demographic of which the shopper is a member. The E-Mail notification feature can also work in conjunction with bonus or special offers which are made available when the user checks out from the system as described above.

In addition to selecting payment options when a purchase is made, a shopper is also made aware of various shipping options, handling policies, privacy issues and product guarantees. The customer has the option of specifying particular delivery options as well.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A concurrent dynamic pricing marketing and sales system for providing buyer access to inventory items of a seller, comprising:
an inventory sales tool accessible to a plurality of buyers through at least one medium;
said inventory sales tool being effective to provide an indication of an available quantity of an item and a plurality of pricing schemes;
at least one of said pricing schemes permits at least one of said buyers to request an immediate purchase at an immediate purchase price; and
at least another of said pricing schemes permits said at least one of said buyers to request a deferred purchase at a deferred purchase price.

2. A marketing system according to claim 1, wherein said at least one medium is a worldwide network of interconnected computers.

3. A marketing system according to claim 1, further comprising:
buyer selectable shopping channels; and
each of said shopping channels permits buyer access to said inventory items based on a type of merchandise.

4. A marketing system according to claim 1, wherein said immediate purchase price decreases over a specified time period when no purchase requests are made.

5. A marketing system according to claim 1, wherein said immediate purchase price increases a specified amount when an immediate purchase is made.

6. A marketing system according to claim 1, wherein said indication is effective to provide information related to purchases by all of said buyers.

7. A marketing system according to claim 1, wherein said item is made available for a limited duration of time.

8. A marketing system according to claim 1, wherein:
said immediate purchase price can fluctuate;
said deferred purchase request includes an open order purchase request made by a first buyer;
said open order purchase request includes an open price;
said open order purchase request being fillable if said open price matches said immediate purchase price; and
said open order purchase request being accessible to no others of said buyers except said first buyer.

9. A marketing system according to claim 1, wherein:
said inventory sales tool includes a lot price for a lot containing a specified quantity of said items;
said lot price and said specified quantity determine an average price for each of said items in said lot;
said deferred purchase request includes a demand purchase request made by said at least one of said buyers;
said demand purchase request includes a demand price;
said demand purchase request being fillable after a prescribed amount of time has passed if said demand price is not less than said average price; and
said demand purchase request being accessible to no others of said buyers except said at least one of said buyers.

10. A marketing system according to claim 9, wherein:
said at least one of said buyers includes at least another buyer;
said deferred purchase request includes at least another demand purchase request made by said at least another buyer;
said at least another demand purchase request includes another demand price;
said demand purchase request and said at least another demand purchase request being both fillable after said prescribed amount of time has passed if a sum of said demand price and said another demand price is not less than a total number of said items requested multiplied by said average price;
said demand purchase request being accessible to no others of said buyers except said at least one of said buyers; and
said at least another demand purchase request being accessible to no others of said buyers except said at least another buyer.

11. A marketing system according to claim 1, wherein a filled immediate purchase decreases said available quantity of said item for said deferred purchase.

12. A marketing system according to claim 1, wherein:
said inventory sales tool includes a minimum auction price;
said deferred purchase request includes an auction purchase request including a bid purchase price;
said auction purchase request being fillable if said bid purchase price is not less than said minimum auction price and said bid purchase price is greater or equal to any other bid purchase price submitted for a like quantity of items.

13. A marketing system according to claim 10, wherein said seller sets said lot price.

14. A marketing system according to claim 12, wherein said seller sets said minimum auction price and a bid purchase price increment by which said bid purchase price is permitted to change.

15. A marketing system according to claim 1, wherein said sell sets a minimum immediate purchase price.

16. A marketing system according to claim 8, wherein:
said inventory sales tool includes a lot price for a lot containing a specified quantity of said items;
said lot price and said specified quantity determine an average price for each of said items in said lot;
said deferred purchase request includes a demand purchase request made by said at least one of said buyers;
said demand purchase request includes a demand price;
said demand purchase request being fillable after a prescribed amount of time has passed if said demand price is not less than said average price; and
said demand purchase request being accessible to no others of said buyers except said at least one of said buyers.

17. A marketing system according to claim 16, wherein:
said inventory sales tool includes a minimum auction price;
said deferred purchase request includes an auction purchase request including a bid purchase price;
said auction purchase request being fillable if said bid purchase price is not less than said minimum auction price and said bid purchase price is greater or equal to any other bid purchase price submitted for a like quantity of items.

18. A marketing system according to claim 1, wherein said inventory items are composed of excess inventory.

19. A marketing system according to claim 17, wherein said inventory items are composed of excess inventory.

20. A marketing system according to claim 2, wherein said inventory sales tool is accessible on a web site.

21. A marketing system according to claim 20, wherein said web site is related to a general buyer interest.

22. A marketing system according to claim 20, wherein said web site is related to a manufacturer of said inventory items.

23. A marketing system according to claim 20, wherein said web site is related to a distributor of said inventory items.

24. A marketing system according to claim 20, wherein said web site is a general purpose web site including at least a search engine.

25. A marketing system according to claim 1, further including an indication showing for a first buyer at least any immediate purchase selections with immediate purchase prices and any deferred purchase selections with deferred purchase prices.

26. A marketing system according to claim 25, wherein said indication is effective to permit said first buyer to complete a sales transaction based on said selections.

27. A marketing system according to claim 25, further including:
a storage medium;
said indication being storable on said storage medium; and
a profile describing purchase trends of said first buyer contains information related to all of said indications stored on said storage medium.

28. A marketing system according to claim 25, further including:
a first buyer notification; and
said first buyer notification containing information related to offers for sale of said inventory items.

29. A marketing system according to claim 28, wherein said first buyer notification operates on an electronic mailing system.

30. A marketing system according to claim 27, further including:
a first buyer notification; and
said first buyer notification containing information related to offers for sale of said inventory items.

31. A system providing buyer purchase choices, comprising:
an inventory content indication effective to provide information about at least a portion of an inventory content including at least one saleable item;
a communication network effective to provide access to said indication for a plurality of users;
a plurality of buying options including at least one of a current purchase option and a deferred purchase option related to said at least one saleable item; and
said communication network effective to provide access to said plurality of buying options for said plurality of users, whereby said plurality of users may modify at least one parameter of any one of said plurality of buying options.

32. A system according to claim 31, wherein said modification of said at least one parameter includes submission of a buy request.

33. A system for providing buyer and seller purchase feedback, comprising:
an inventory content indication effective to provide information about at least a portion of an inventory content including a plurality of saleable items;
a plurality of variable prices related to each of said saleable items;
a communication network effective to provide access to at least one of said indication and said prices for a plurality of buyers and at least one seller;
a plurality of buying options including at least one of a current purchase option and a deferred purchase option related to said at least one of said indication and said prices;
said buying options permit said buyers to submit purchase requests; and
said at least one seller can modify parameters of said buying options.

34. A method of offering inventory items for sale, comprising:
providing to a buyer an indication of available quantities for inventory items of a seller;
providing to said buyer a plurality of pricing schemes for said inventory items;
at least one of said pricing schemes permitting said buyer to request an immediate purchase at an immediate purchase price;
at least another of said pricing schemes permitting said buyer to request a deferred purchase at a deferred purchase price; and filling said purchase requests if said purchase prices meet specific criterion.

35. A method according to claim 34, wherein:
said deferred purchase includes at least one of an open order; a demand order and an auction bid order;
filling said open order if a related open order purchase price is not less than said immediate purchase price;
filling said demand order within a specified period of time if a related demand order price is not less than an average lot price for an inventory lot including said inventory items; and
filling said auction bid order if a related auction bid order price is greater than any other auction bid order price.

36. A method according to claim 35, wherein said method is operable over a network of interconnected computers.

37. A method according to claim 34, wherein said inventory items comprise excess inventory including at least one of excess items, returned items and repaired items.

38. An article of manufacture comprising a computer readable medium in which is stored a computer program for offering inventory items for sale, the computer program comprising:
a first code segment executable to provide to a buyer an indication of available quantities for inventory items of a seller;
a second code segment executable to permit said buyer to request an immediate purchase at an immediate purchase price;
a third code segment executable to permit said buyer to request a deferred purchase at a deferred purchase price; and
a fourth code segment executable to fill said purchase requests if said purchase prices meet specific criterion.

39. A tool for providing a buyer and seller access to an inventory, comprising:
an indication of quantities of inventory items;
a current price associated with each of said inventory items;
a deferred price associated with each of said inventory items;
an offer facility which permits said seller to set parameters associated with said prices;
a purchase facility which permits said buyer to select purchases from among said inventory items for purchase; and
said selected purchases can be made at either a current price or a deferred price.

40. A tool according to claim 39, wherein said tool can be provided on a web site accessible to said buyer.
